(19) United States
(12) Patent Application Publication
(10) Pub. No.: US 2015/0122238 A1
(43) Pub. Date: May 7, 2015

(54) Method and device for checking a functional capability of an internal combustion engine which is operated by a multi-fuel system

(71) Applicants: Sergey Antonov, Heilbronn (DE); Oliver Fautz, Ludwigsburg (DE); Alexander Dubs, Bruchsal (DE)

(72) Inventors: Sergey Antonov, Heilbronn (DE); Oliver Fautz, Ludwigsburg (DE); Alexander Dubs, Bruchsal (DE)

(21) Appl. No.: 14/362,466

(22) PCT Filed: Nov. 13, 2012
(86) PCT No.: PCT/EP2012/072499

§ 371 Date: Jun. 3, 2014

(30) Foreign Application Priority Data
Dec. 8, 2011 (DE) 10 2011 087 988.9

(51) Int. Cl. F02D 41/30; F02D 41/22; F02M 43/04

(52) U.S. Cl. CPC F02D 41/3005; F02M 43/04; F02D 41/22
USPC 123/575

(57) ABSTRACT

A method for checking a functional capability of an internal combustion engine operated by a multi-fuel system, in which method at least two control devices electronically control a combustion process of the internal combustion engine with a different fuel, each control device having a dedicated safety concept, and a system functionality of the multi-fuel system being divided among the at least two control devices. To describe an overall safety concept, one control unit, which may be one of the at least two control devices, monitors the overall system functionality of the multi-fuel system.

### FIELD OF THE INVENTION

The invention relates to a method for checking a functional capability of an internal combustion engine operated by a multi-fuel system, in which method at least two control devices electronically control a combustion process of the internal combustion engine with a different fuel, each control device having a dedicated safety concept, and a system functionality of the multi-fuel system being divided among the at least two control devices; and to an apparatus for carrying out the method.

### BACKGROUND INFORMATION

Motor vehicles that are embodied as so-called bi-fuel vehicles are known. “Bi-fuel” refers to a gasoline/natural gas system that is operated either only with natural gas or only with gasoline, or in mixed fashion. A bi-fuel vehicle allows an operating mode in which either the gaseous fuel is delivered into the internal combustion engine of the motor vehicle and/or the liquid fuel is injected into a cylinder of the internal combustion engine of the motor vehicle. In contrast thereto, a diesel/gas system, which can operate in pure diesel mode or in mixed diesel/gas mode, is referred to as “dual-fuel.”

These bi-fuel or dual-fuel concepts are implemented using an electronic control system, one or more control devices for regulating combustion of the internal combustion engine being utilized. A large majority operate with Otto-cycle or gas combustion processes. The control devices control the internal combustion engine, each control device having a dedicated safety concept that is constructed in three levels and is utilized for continuous monitoring of safety-relevant data of the respective control device. For each control device, however, only those data which are required for combustion regulation with the fuel associated with the control device are checked.

### SUMMARY OF THE INVENTION

An object on which the invention is based is that of describing a method for checking a functional capability of an internal combustion engine operated by a multi-fuel system, in which method a monitoring of the overall system functionality of the multi-fuel system is carried out using all control devices participating in the operation of the internal combustion engine.

The object may be achieved according to the present invention in that one control unit, which may be one of the at least two control devices, monitors the overall system functionality of the multi-fuel system. This has the advantage that overall system monitoring can occur using different methods, for example monitoring of torque, rotation speed, acceleration, or coasting. The overall system monitoring can take place in any desired control unit, for example a diesel control device or a gas control device, that are constituents of the multi-fuel system. Monitoring is also possible, however, by way of other control units of the vehicle that, like a vehicle management computer, are not provided directly for operation of the internal combustion engine. This concept is thus universally suitable both for dual-fuel systems (i.e. systems that can combust two fuels, for example diesel and natural gas) and for multi-fuel systems that can process more than two fuels.

Advantageously, the control unit monitoring the overall system functionality monitors safety-relevant setpoints and/or safety-relevant actual values of the system functionality of the multi-fuel system, which may be continuously. It is thus even possible for control devices that have no dedicated safety concept to be monitored by a different control unit that does have a safety concept, the overall functionality of the multi-fuel system always being considered.

In an embodiment, for monitoring of the overall system functionality of the multi-fuel system a setpoint, which may be a driver's torque request, of the overall multi-fuel system is compared with a totality of, in particular summed, actual values of the overall multi-fuel system, a fault reaction being executed if the totality of the actual values exceeds the setpoint. A comparison of the desired setpoint with the actual values in fact implemented by the multi-fuel system represents a particularly simple but effective method of monitoring the multi-fuel system.

In a variant, the fault reaction creates a controllable state of a motor vehicle that is being driven by the internal combustion engine operated with the multi-fuel system, the fault reaction may be embodied in steps such that the internal combustion engine continues to be operated with a first fuel while operation with the second fuel is suppressed. The method is thus suitable for bringing about a safe state of the internal combustion engine, and thus of the vehicle, in the event of a fault. This concept is, however, just as capable of bringing about a substitute operating mode for controlling the internal combustion engine and thus the vehicle, since the necessary redundancy exists as a result of multiple control devices acting mutually independently.

In an embodiment, the safety concept of each control device encompasses a first application-specific level that is monitored in safety-critical fashion by a second level, while a third level performs monitoring of the hardware of the control device. By way of this standardized three-level monitoring, the control device is completely monitored in terms of its function. The result is to ascertain reliably whether the control device is meeting the demands placed on it.

In a variant, monitoring of the overall system functionality of the multi-fuel system is performed in the second level of the corresponding control device. Because this second level is, in particular, already embodied for safety-critical monitoring of the application function executing in the first level of the control device, monitoring of the overall functionality of all control devices participating in operation of the internal combustion engine is easily adapted by inserting an additional software module into that second level of the safety concept. A separate safety concept for monitoring the overall functionality of the multi-fuel system can be dispensed with.

Advantageously, the messages exchanged between the at least two control devices of the multi-fuel system are embodied to be intrinsically safe. “Intrinsic safety” is understood to mean that all messages received and sent out by the control devices are regarded as correct, since they are continuously checked for plausibility during operation of the internal combustion engine.

In an embodiment, the intrinsic safety of the exchanged messages is checked in terms of integrity and/or currency. A checksum test is carried out as an integrity test, a determination being made as to whether the checked data are in fact plausible. The currency test is carried out by way of a message counter that is incremented at each message. If this counter is not incremented further, it is assumed that a software element or hardware element is defective.

A refinement of the invention relates to a control device for electronic control of an internal combustion engine operated by a multi-fuel system, which device controls operation of the internal combustion engine with a first fuel and emits signals to and/or receives signals from a second control device that is operating the internal combustion engine with a second fuel, and has a safety concept, made up of three levels, for checking safety-relevant signals. In a control device whose safety relevance is expanded, a monitoring arrangement is present which monitors an overall functionality of the multi-fuel system for operating the internal combustion engine. All signals that are processed by the control device itself, or that that control device receives from other control devices, are assembled into a totality that permits conclusions as to the safety of the overall multi-fuel system. An overall monitoring system of this kind can be implemented in any desired control device that is used in the motor vehicle and has a safety concept.

Advantageously, monitoring of the overall functionality of the multi-fuel system is carried out in a second safety-relevant level of the safety concept. Because this second level of the safety concept is already provided for checking safety-relevant data, an additional monitoring functionality of this kind can easily be implemented in that level.

The invention permits numerous embodiments. One of them will be explained in further detail with reference to the Figures depicted in the drawings. Identical features are identified with identical reference characters.

### BRIEF DESCRIPTION OF THE DRAWINGS

FIG. 1 schematically depicts a diesel/natural gas system for controlling an internal combustion engine.

FIG. 2 is a system overview of the diesel/gas control system having two control devices.

FIG. 3 schematically depicts torque monitoring of the overall diesel/gas system according to FIG. 2.

FIG. 4 is a system overview of a gas control system with continuous torque monitoring of the overall diesel/gas system according to FIG. 2.

FIG. 5 is a system overview of the diesel control system with continuous torque monitoring.

### DETAILED DESCRIPTION

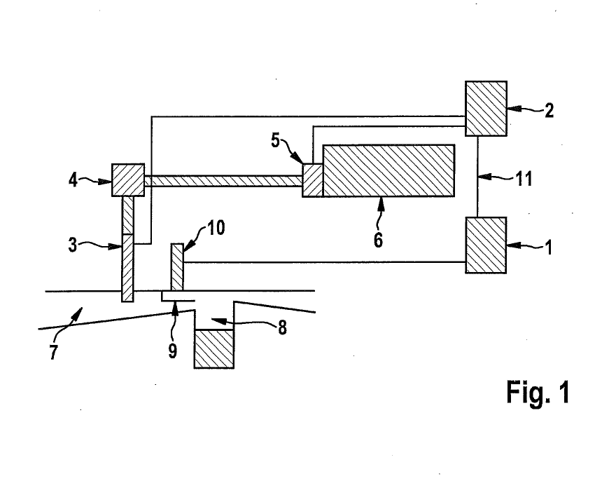

FIG. 1 is a schematic depiction of a dual-fuel system having a diesel control device 1 and a gas control device 2. A gas injector 3 is connected via a gas pressure regulator 4 and a gas shutoff valve 5 to a gas tank 6, and projects into intake region 7 of the internal combustion engine (not further depicted) into which the gaseous fuel is delivered. The internal combustion engine has, close to cylinder 8, a prechamber 9 into which diesel fuel, which is used as a liquid fuel, is injected. This occurs via a diesel injector 10 that is controlled by diesel control device 1. Diesel control device 1 is connected to gas control device 2 that regulates the introduction of the gaseous fuel. Diesel control device 1 is connected to gas control device 2 via a bidirectional interface in the form of, for example, a CAN bus 11, the two control devices 1, 2 communicating via CAN bus 11.

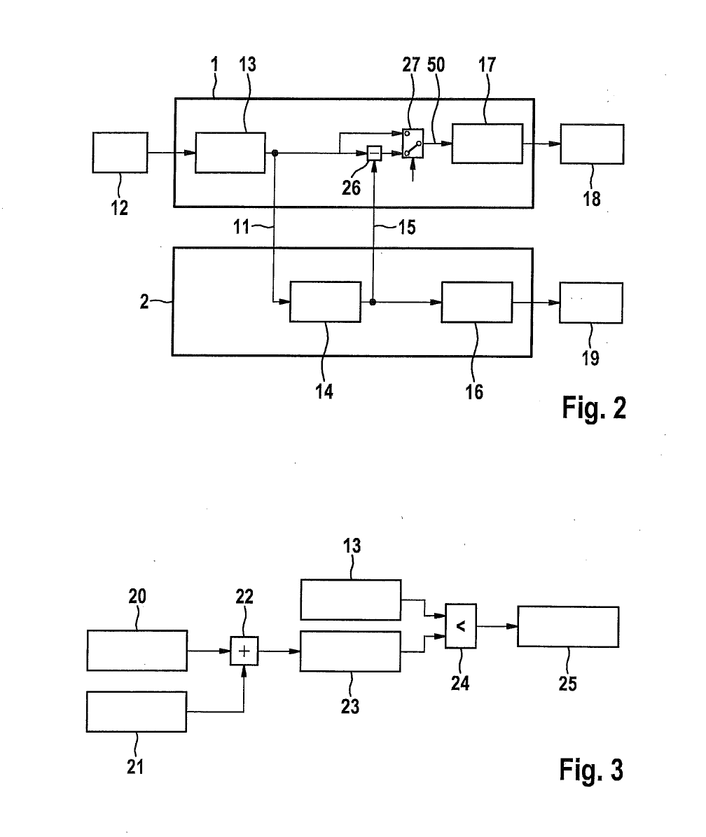

FIG. 2 illustrates a system overview of the dual-fuel control system, depicted in FIG. 1, of the internal combustion engine. Each of the control devices 1, 2 discussed encompasses a respective safety concept that is made of three levels. The first level encompasses the application software, the second level deals with the monitoring of safety-critical signals of the first level, while the third level monitors the hardware of the respective control device 1, 2 in terms of its function. In FIG. 2, diesel control device 1 and gas control device 2 are depicted at their first level I of the application software, illustrating in particular the operative connection in terms of the function of delivering fuel to the internal combustion engine. Diesel control device 1 receives an input signal 12, for example as a consequence of actuation of an accelerator pedal by a driver, whereupon a setpoint in the form of a total torque request 13 is calculated in diesel control device 1. Said total torque request 13 is transmitted via an intrinsically safe CAN bus 11 to gas control device 2. Located in plane I of gas control device 2 is a torque distribution logic system 14 that determines the proportions of liquid fuel in the form of diesel, and gaseous fuel, that participate in achieving the total torque request 13. From the total torque request 13, a gas torque request 38 is calculated for the gas path and is conveyed again via communication lead 15 to diesel control device 1. The diesel torque request 50 is calculated as the difference between the total torque request 13 and gas torque request 38.

On the basis of the diesel torque request 50 for the diesel fuel, and the gas torque request 38 for the gas to be used, that are thereby obtained, control is applied to the respective fuel injection systems 16 and 17. An injection system 17 applies control to output stages 18 of diesel injection nozzles 10, while an injection system 16 applies control to output stages 19 of gas injector 3, in order to ensure injection into the internal combustion engine of the quantities of respectively liquid and gaseous fuel derived in accordance with the diesel torque request 50 and gas torque request 38.

Because safety of the individual gas control device 2 and individual diesel control device 1 does not guarantee safety of the overall diesel/gas system, a continuous monitoring of the ascertained total torque request 13 is carried out according to FIG. 3 using the actual torques in fact ascertained. FIG. 3 is a schematic sketch of torque monitoring of an overall diesel/gas system of this kind. Firstly the actual diesel torque 20 that is generated by the diesel fuel, and the actual gas torque 21 that is generated by the gas, are added at node 22. This total actual torque 23 thus ascertained is compared with the total torque request 13. At node 24 a determination is made as to whether the total torque request 13 is still greater than the total actual torque 23. If so, diesel and the gaseous fuel continue to be respectively delivered to the internal combustion engine. If it is found at node 24 that the total actual torque 23 significantly exceeds the total torque request 13, then a fault reaction 25 is executed after a commensurate delay time. This fault reaction can on the one hand bring about a fail-safe strategy such that the state of the internal combustion engine and thus of the motor vehicle remains controllable. Alternatively, however, a fail-operation strategy can also be executed as fault reaction 25, in which strategy a substitute operating mode for the internal combustion engine and the motor vehicle is executed in the event of a fault. It is thereby possible to ensure, for example, that only liquid fuel (in the form of diesel) is injected into the internal combustion engine, while delivery of gas is suppressed. For this, the gas torque request 38 in gas control device 2 is set to zero, and the total torque request 13 is switched over by switch 27 to the diesel torque request 50.

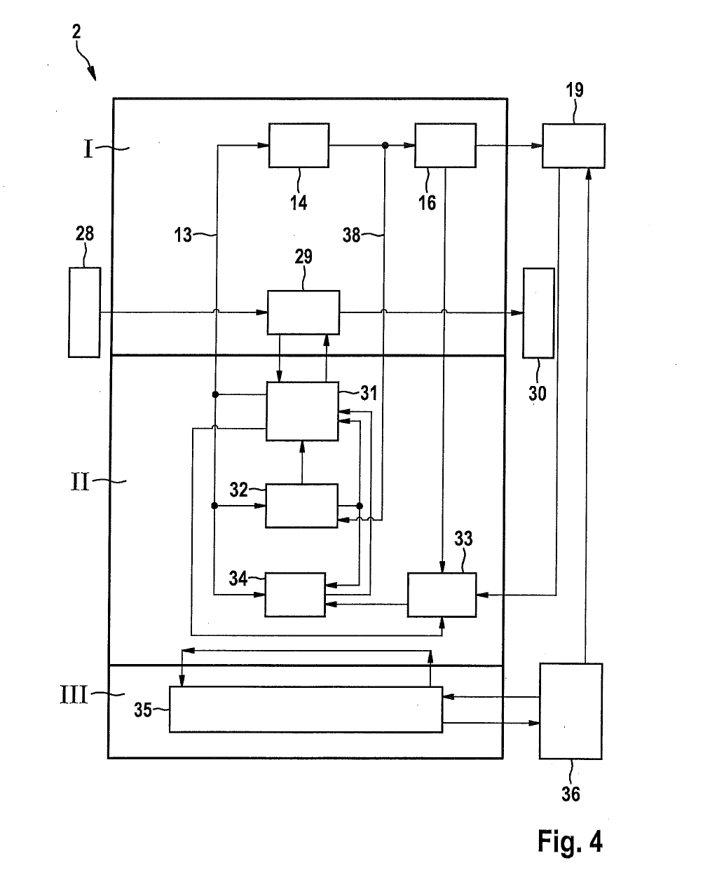

FIG. 4 depicts a system overview of a gas control system with continuous total torque monitoring of the overall dual-fuel system made up of diesel control device 1 and gas control device 2. Gas control device 2 has a safety concept in three levels I, II, and III. Via block 28, diesel control device 1 is connected via CAN bus 11 to a block 29 in level I of gas control device 2 which receives and sends messages. This block 29 not only receives messages from diesel control device 1, but also delivers messages via communication lead 15 to diesel control device 1 (block 30). Gas control device 2 has the task of implementing safety monitoring for the entire diesel/gas system. For that purpose, the transmitted and received messages of block 29 are forwarded to or received by level II, in particular at block 31. The purpose of block 31 is to safeguard communication, ensuring that communication between the participating control devices 1, 2 is intrinsically safe. For this, the CAN messages from gas control device 2 are monitored by testing the integrity of the CAN messages by way of a checksum test. Currency of the CAN messages is carried out by way of a message counter test. In order to safeguard the CAN messages for transmission with respect to integrity and currency counters, a checksum is likewise calculated and a message counter is made available.

The total torque request 13, which is regarded as the setpoint of the overall diesel/gas system, is conveyed to block 32, which monitors the torque distribution strategy 14. Gas torque request calculation for the gas path is safeguarded in that context, meaning that that gas torque request 38 which is to be implemented via gas combustion is defined. In this block 32, the logic of the torque distribution strategy 14 of the application software of level I is computed in simplified fashion, and substitute values are determined in the event of a fault. This procedure results in continuous safeguarding of the safety-relevant setpoints that are used in gas control device 2.

In the functionality of block 33, the total actual torque 23 of the diesel/gas system, made up of the actual diesel torque 20 of diesel control device 1 and the actual gas torque 21 of gas control device 2, is calculated. The total actual torque 23 is made up of the sum of the actual diesel torque 20 and actual gas torque 21, as already explained in connection with FIG. 3. The safety-relevant actual torques are safeguarded by this functionality of block 33. The gas torque request 38 of the gas path is calculated in gas control device 2 and conveyed from injection system 16 of plane I to the functionality in block 33. The actual diesel torque 20 of the diesel path is transmitted from diesel control device 1 via the safeguarded CAN bus 11 (block 28). This transmission occurs after testing of secure communication by block 31. The actual diesel torque 20 of diesel control device 1 and the actual gas torque 21 of gas control device 2 can also be calculated differently. For example, a measurement of the crankshaft torque with the aid of a sensor, an estimate of the crankshaft torque by evaluating the crankshaft rotation speed oscillation, or the like, are possible.

The torque comparison for the overall diesel/gas system occurs in block 34. Here a comparison is carried out between the total torque request 13 of the overall diesel/gas system, used as setpoint, and the summed actual diesel and gas torque 23 of the overall diesel/gas system, which is regarded as the actual value, the safety-relevant setpoints and safety-relevant actual values of the overall diesel/gas system being continuously considered. The gas path can additionally be plausibilized by making a comparison between the actual gas torque 21 and the permissible gas torque request 38 of the gas path.

For the sake of completeness, level III of the safety concept of gas control device 2 will also be discussed. This level III encompasses a functionality for hardware monitoring 35 which is plausibilized by an external monitoring unit 36. In the context of plausibilization, a query is outputted to hardware monitoring system 35 and is responded to by hardware monitoring system 35. If the response corresponds to the expected response, the hardware is regarded as functional. If the response does not correspond to the expected response, external monitoring unit 36 then shuts down output stage 19 of gas valves 3 via a redundant shutdown path.

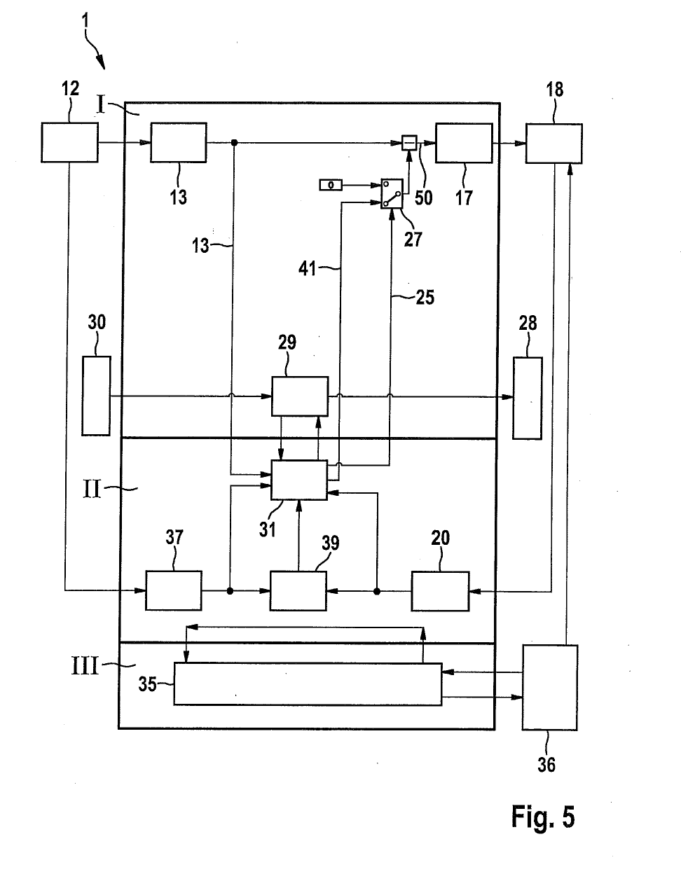

FIG. 5 depicts a system overview for the safety concept of diesel control device 1, diesel control being accomplished with continuous torque monitoring in the control-device network of a dual-fuel system. Diesel control device 1 also has the three levels I, II, III of the safety concept. But because monitoring of the overall diesel/gas system is implemented in gas control device 2, only the additional functionalities not present in the gas control device will be referred to here. Diesel control device 1 communicates via block 30 with gas control device 2; a block 29 for sending and receiving messages is also present in level I of diesel control device 1, said block communicating with gas control device 2 via a communication interface 28. Diesel control device 1 as well contains, on level II, a block 31 for safeguarding communication, in order to ascertain whether the exchanged messages are in fact fault-free. The permissible diesel torque request 37 is calculated in level II, similarly to the total torque request 13 of level I. The actual diesel torque 20 actually established at output stages 18 of diesel injection nozzles 10 is conveyed, together with the permissible diesel torque request 37, to a block 39 in which the torque comparison between the diesel torque request 37 and actual diesel torque 20 is carried out. If a fault occurs, it is forwarded via lead 40 to block 31 for safeguarding communication, and from there to gas control device 2.

The method explained is usable for all possible multi-fuel systems having an electronic control system, for example in diesel/gas, diesel/ethanol, or other systems. “Multi-fuel systems” are understood here as those systems which work with two or more fuels. Monitoring of the overall functionality of the multi-fuel system can be implemented in a control device of the multi-fuel system. It is also conceivable, however, for a control unit of the motor vehicle to take on this monitoring task, said unit not being a constituent of the multi-fuel system.

1-10. (canceled)

11. A method for checking a functional capability of an internal combustion engine operated by a multi-fuel system, the method comprising:
electronically controlling, with at least two control devices, a combustion process of the internal combustion engine with a different fuel;
wherein each of the at least two control devices includes a dedicated safety arrangement, wherein a system functionality of the multi-fuel system is divided among the at least two control devices, and wherein one control unit monitors the overall system functionality of the multi-fuel system.

12. The method of claim 11, wherein the control unit monitoring the overall system functionality monitors at least one of safety-relevant setpoints and safety-relevant actual values of the overall system functionality of the multi-fuel system.

13. The method of claim 12, wherein for monitoring of the overall system functionality of the multi-fuel system a setpoint of the overall multi-fuel system is compared with a totality of actual values of the overall multi-fuel system, a fault reaction being executed if the totality of the actual values exceeds the setpoint.

14. The method of claim 13, wherein the fault reaction creates a controllable state of a motor vehicle that is being driven by the internal combustion engine operated with the multi-fuel system.

15. The method of claim 11, wherein the safety arrangement of each of the control devices encompasses a first application-specific level (I) that is monitored in a safety-critical manner by a second level (II), while a third level (III) performs monitors the hardware of the control device.

16. The method of claim 11, wherein monitoring of the overall system functionality of the multi-fuel system is performed in the second level (II) of the corresponding control device.

17. The method of claim 11, wherein the messages exchanged between the at least two control devices of the multi-fuel system are intrinsically safe.

18. The method of claim 17, wherein the intrinsic safety of the exchanged messages is checked in terms of at least one of integrity and currency.

19. A control device for electronic control of an internal combustion engine operated by a multi-fuel system, comprising:
a controller arrangement to control operation of the internal combustion engine with a first fuel and at least one of emits signals to and receives signals from a second control device that is operating the internal combustion engine with a second fuel;
wherein the control arrangement includes a safety arrangement having three levels (I; II; III) for checking safety-relevant signals, and wherein the control arrangement also monitors an overall functionality of the multi-fuel system for operating the internal combustion engine.

20. The control device of claim 19, wherein monitoring of the overall functionality of the multi-fuel system is carried out in a second safety-relevant level (II) of the safety concept.

21. The method of claim 11, wherein the one control unit is one of the at least two control devices.

22. The method of claim 11, wherein the control unit monitoring the overall system functionality monitors at least one of safety-relevant setpoints and safety-relevant actual values of the overall system functionality of the multi-fuel system, continuously.

23. The method of claim 12, wherein for monitoring of the overall system functionality of the multi-fuel system a setpoint, which is a total torque request, of the overall multi-fuel system is compared with a totality of, which is summed, actual values, which is the actual diesel torque and the actual gas torque, of the overall multi-fuel system, a fault reaction being executed if the totality of the actual values exceeds the setpoint.

24. The method of claim 13, wherein the fault reaction creates a controllable state of a motor vehicle that is being driven by the internal combustion engine operated with the multi-fuel system, the fault reaction being embodied in steps such that the internal combustion engine continues to be operated with a first fuel while operation with the second fuel is suppressed.
